(19) United States
(12) Patent Application Publication
(10) Pub. No.: US 2022/0268207 A1
(43) Pub. Date: Aug. 25, 2022

(54) METHOD OF OPERATING A GAS TURBINE ENGINE, COMPRESSED AIR DELIVERY SYSTEM AND AIRCRAFT INCORPORATING SAME

(71) Applicant: PRATT & WHITNEY CANADA CORP., Longueuil (CA)

(72) Inventors: Ninad JOSHI, Brampton (CA); Jason HERBORTH, Acton (CA)

(21) Appl. No.: 17/179,936

(22) Filed: Feb. 19, 2021

(51) Int. Cl. F02C 6/08; B64D 13/02

(52) U.S. Cl. CPC F02C 6/08; B64D 13/02; F05D 2220/323; F05D 2220/50; F05D 2260/60

(57) ABSTRACT

There is described a method of operating a gas turbine engine having a rotor rotatable about a rotation axis, a core gas path defined annularly around the rotation axis, and a casing defining a wall to the core gas path. The method generally has: generating compressed air from a compressed air source, the compressed air source being external relative the gas turbine engine; and guiding the compressed air in sequence from the compressed air source, radially inwardly relative the rotation axis, through a bleed port and into the core gas path.

### TECHNICAL FIELD

The disclosure generally relates to the operation of a gas turbine engine, and more particularly relates to the delivery of compressed air to the gas turbine engine.

### BACKGROUND OF THE ART

Rotor bow, sometimes referred to as thermal bow, is a phenomena associated with engine shafts where different engine parts are each exposed to different thermal loading. For example, when an aircraft engine enters a shut down phase after landing, the engine/combustor continues to reject heat to its adjacent components. The rejected heat rises against gravity, leaving the upper sectors hotter than the lower sectors. This uneven thermal loading results in a differential thermal expansion which can ultimately result in slender components such as shafts to deflect, resulting in a bowed rotor condition. Under a bowed rotor condition, a subsequent start could lead to undesired occurrences of component rubbing.

Although existing rotor bow prevention techniques such as continuing to operate the engine shaft to rotate the fans are satisfactory to a certain degree, there remains room for improvement.

### SUMMARY

In one aspect, there is provided a method of operating a gas turbine engine, the gas turbine engine having a rotor rotatable about a rotation axis, a core gas path defined annularly around the rotation axis, and a casing defining a wall to the core gas path, the method comprising: generating compressed air from a compressed air source, the compressed air source being external relative the gas turbine engine; and guiding the compressed air in sequence from the compressed air source, radially inwardly relative the rotation axis, through a bleed port and into the core gas path.

In another aspect, there is provided a compressed air delivery system for an aircraft having a gas turbine engine, an aircraft system, and a fluid conduit network, the gas turbine engine having a rotor rotatable about a rotation axis, a core gas path defined annularly around the rotation axis, a casing defining a wall to the core gas path, a bleed port in the wall, open to the core gas path, the fluid conduit network configured for fluidly connecting the bleed port to the aircraft system sequentially via an engine conduit extending radially outwardly relative the rotation axis and an aircraft conduit extending externally relative the gas turbine engine, the compressed air delivery system comprising: at least one valve and an external source conduit fluidly integrated to the fluid conduit network, the at least one valve selectively operable to a first configuration fluidly connecting the engine conduit to the aircraft conduit and partitioning the external source conduit, and a second configuration fluidly connecting the engine conduit to the external source conduit and partitioning the aircraft conduit.

In a further aspect, there is provided an aircraft comprising: an aircraft system; a gas turbine engine having a rotor rotatable about a rotation axis, a core gas path defined annularly around the rotation axis, a casing defining a wall to the core gas path, a bleed port in the casing open to the core gas path; a fluid conduit network configured for fluidly connecting the bleed port to the aircraft system sequentially via an engine conduit extending radially outwardly relative the rotation axis and an aircraft conduit extending externally relative the gas turbine engine, the fluid conduit network having a valve and an external source conduit fluidly integrated thereto; and a compressed air source configured for generating compressed air and guiding the compressed air into the external source conduit; the valve being selectively operable to a first configuration fluidly connecting the engine conduit to the aircraft conduit, and to a second configuration fluidly connecting the engine conduit to the external source conduit and partitioning the aircraft conduit.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying figures in which:

FIG. 1 is a schematic cross-sectional view of a gas turbine engine, in accordance with the prior art;

FIG. 2 is a schematic cross-sectional view of an example of a compressed air delivery system configured to deliver compressed air to the gas turbine engine of FIG. 1, in accordance with one or more embodiments;

FIG. 3 is a diagram showing another example of a compressed air delivery system, shown with a fluid conduit network having a single valve, in accordance with one or more embodiments;

FIG. 4 is a diagram showing another example of a compressed air delivery system, shown with a fluid conduit network having multiple valves, in accordance with one or more embodiments;

FIG. 5A is a schematic cross-sectional view of an example of a gas turbine engine having a first unsupported length, in accordance with one or more embodiments;

FIG. 5B is a schematic cross-sectional view of an example of a gas turbine engine having a second unsupported length being greater than the first unsupported length, in accordance with one or more embodiments; and

FIG. 6 is a flow chart of a method of delivering compressed air to a gas turbine engine, in accordance with one or more embodiments.

### DETAILED DESCRIPTION

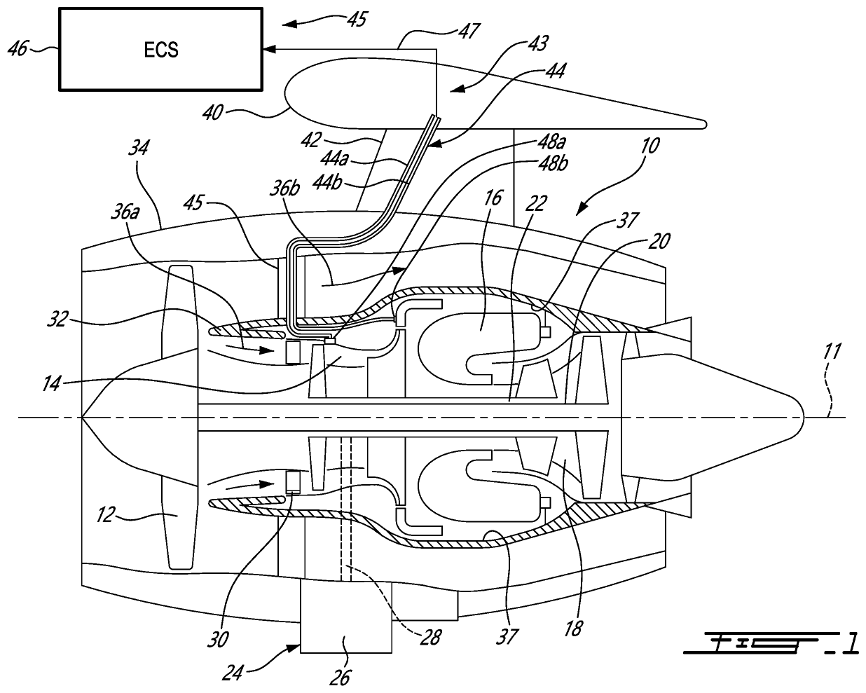

FIG. 1 illustrated a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

The fan 12 is drivingly interconnected, directly or indirectly, to low pressure rotor(s) of the turbine section 18 through a low pressure shaft 20, and the high pressure rotor(s) of the compressor section 14 is/are drivingly connected to high pressure rotor(s) of the turbine section 18 through a high pressure shaft 22 concentrically surrounding the low pressure shaft 20. The gas turbine engine 10 has a rotation axis 11 about which rotatable components of the gas turbine engine 10, such as the low and high pressure rotor(s), rotates during use.

The gas turbine engine 10 may include an accessory drive assembly 24 which includes an accessory gearbox (AGB) 26. Although not shown, the accessory drive assembly 24 can also include a pump assembly and/or an air starter generator. The accessory drive assembly 24 may be driven by the high pressure shaft 22 via an accessory shaft 28 which drivingly interconnects the high pressure shaft 22 and the accessory gearbox 26. Bearings 30 may be used to rotatably support different components of the engine 10, such as the low and high pressure shafts 20 and 22, and components of the accessory gearbox 26.

The gas turbine engine 10 has a casing 32 which encloses the turbo machinery of the engine, and an outer casing or nacelle 34 disposed radially outwardly of the casing 32. The casing 32 and the nacelle 34 collectively define two compressed gas paths 36 in this embodiment, including a core gas path 36a and a bypass gas path 36B. The air propelled by the fan 12 is split into a first portion which flows through the core of the engine via the core gas path 36a, which is circumscribed by a radially outer wall 37 of the casing 32 and allows the flow to circulate through the multistage compressor 14, combustor 16 and turbine section 18 as described above. The remainder portion of the propelled air flows around the casing 32 within the bypass gas path 36B.

As depicted, the nacelle 34 is generally suspended to an aircraft wing 40 (or fuselage) via a pylon 42. A fluid conduit network 43 is provided. As shown, the fluid conduit network 43 is configured for fluidly connecting the core gas path 36a to an aircraft system 45 sequentially via engine conduit 44 extending radially outwardly relative the rotation axis 11 and an aircraft conduit 47 extending externally relative the gas turbine engine 10. Examples of such engine conduits include compressed air conduits 44a and 44b which in this example fluidly connect portions of the core gas path 36a to the aircraft conduit 47 which itself leads to an environmental control system (ECS) 46 or any other aircraft system. As shown in this embodiment, the compressed air conduits 44a and 44b can convey compressed air bleeding from the core gas path 36a via corresponding bleed ports, such as low and high pressure bleed ports 48a and 48b. The compressed air conduits may 44a and 44b run through strut(s) 45, the pylon 42 and/or the aircraft wing 40 depending on the embodiment. As compressed air originating from the low pressure bleed port 48a may be of lower pressure and lower temperature, compressed air originating from the high pressure bleed port 48b may be of higher pressure and higher temperature. As shown in this embodiment, the low pressure bleed port 48a is located at a lower pressure portion of the core gas path 36a whereas the high pressure bleed port 48b is located at a higher pressure portion of the core gas path 36a. The locations of the bleed ports are carefully optimized depending upon the flight envelope of the aircraft and the engine power settings, and can thereby differ from one embodiment to another. Bleed port(s) may be located in the nacelle 34 and open to the bypass gas path 36b. In some embodiments, the gas turbine engine may have one, two, three or more bleed ports located at different portions of the core gas path 36a. During normal working conditions of the gas turbine engine 10, the pressurized air originating from the low and high pressure bleed ports 48a and 48b can be mixed to one another so as to be used by the ECS 46 to control cabin pressure. Other aircraft systems can be configured for de-icing the nacelle front lip and wings, and start the other engines, for instance. For instance, the pressurized air originating from the low and high pressure bleed ports 48a and 48b, and perhaps from bleed ports open to the bypass gas path 36b, can be mixed to one another using a mixer to obtain pressurized air of a given pressure and temperature where desired.

It is known that when the gas turbine engine 10 enters a shut down phase after landing, the hot components progressively cool down and by doing so dissipate heat therearound, which can heat up adjacent components unevenly. The rejected heat can rise against gravity, leaving the hardware in upper sectors hotter than the hardware in the lower sectors. This uneven thermal loading results in a differential thermal expansion of long and slender components like the low and high pressure shafts 20 and 22 causing them to deflect, resulting in a bowed rotor condition. Under a bowed rotor condition, a subsequent start of the gas turbine engine 10 can lead to unexpected component rubs. It is thus desirable to deliver compressed air to either one or both the low and high pressure shafts 20 and 22, or other components of the gas turbine engine 10, for a given period of time after the shutting down of the gas turbine engine 10 has been initiated, for instance. Delivering compressed air to the components surrounding the core gas path 36 may also be used in embodiments where the gas turbine engine 10 is to be pre-heated prior to ignition.

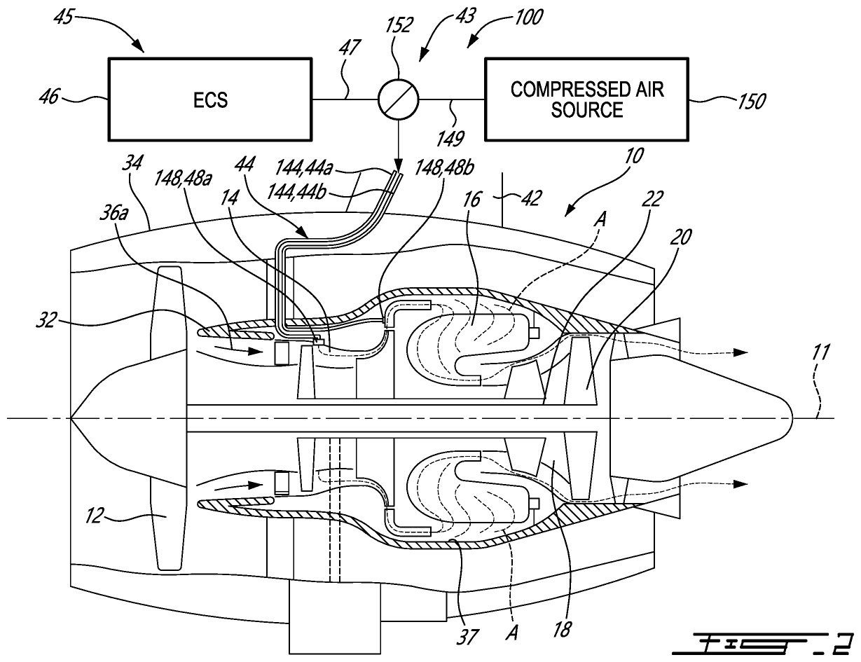

FIG. 2 shows an example of a compressed air delivery system 100 for an aircraft having a gas turbine engine 10, an aircraft system 45 and a fluid conduit network 43. The compressed air delivery system 100 can be used with any type of gas turbine engine including, but not limited to, a turbofan engine, a turboshaft engine and the like. The operation of the compressed air delivery system 100 can be manually or automatically controlled depending on the embodiment. As shown, the gas turbine engine 10 having a rotor rotatable about a rotation axis 11, a core gas path 36a defined annularly around the rotation axis 11, a casing 32 defining a wall 37 to the core gas path 36a, a bleed port 148 in the casing 32 open to the core gas path 36a. The fluid conduit network 43 fluidly connects the bleed port 148 to the aircraft system 45 sequentially via engine conduit(s) 144 extending radially outwardly relative the rotation axis 11 and an aircraft conduit 47 extending externally relative the gas turbine engine 10.

As depicted, the compressed air delivery system 100 has one or more valve 152 and an external source conduit 149 fluidly integrated to the fluid conduit network 43. The valve(s) 152 is selectively operable to a first configuration fluidly connecting the engine conduit(s) 144 to the aircraft conduit 47, and to a second configuration fluidly connecting the engine conduit(s) 144 to the external source conduit 149 and partitioning the aircraft conduit 47. The valve 152 can be any suitable type of valve including, but not limited to, butterfly valve, knife-gate valve, ball-type valve, bi-directional valve, and the like. For instance, in the first configuration the valve 152 can prevent the compressed air to flow through the bleed port(s) 148. In the second configuration the valve 152 to can allow the compressed air to flow radially inwardly through the bleed port(s) 148 and into the core gas path 36a while preventing the compressed air from being guided in the aircraft conduit 47.

As depicted, the gas turbine engine 10 includes one or more bleed ports 148. Examples of the bleed port(s) 148 can include, but are not limited to, the low and high bleed ports 48a and 48b described above. As shown, the bleed port(s) 148 are in fluid communication with the core gas path 36a of the gas turbine engine 10. More specifically, the bleed port(s) 148 can be axially or circumferentially spaced from one another along casing 32.

The fluid conduit network 43 includes one or more engine conduit(s) 144. Examples of the engine conduit(s) 144 can include, but not limited to, the engine conduits 44a and 44b that are in communication with the low and high pressure bleed ports 48a and 48b. As shown, the engine conduit(s) 144 are in fluid communication with the bleed port(s) 148. The engine conduits 144 may be used for bleeding compressed air out of the core gas path 36a via the bleed port(s) 148 and towards the aircraft conduit 47 leading to the environmental control system 46 during normal working conditions of the gas turbine engine 10. Although each bleed port 148 has its own dedicated engine conduit 144 in the illustrated embodiment, a single engine conduit 144 can be fluidly connected to more than one of the bleed ports 148. Also, a single bleed port 148 can be fluidly connected to more than one engine conduit 144 in some other embodiments. The bleed ports 148 are part of the compressor section 14 or combustor 16 of the gas turbine engine 10. As depicted, the corresponding engine conduits 44b and 44c run from the bleed ports 158, through the casing 32, the strut 45, the nacelle 34 and pylon 42 towards the aircraft.

A compressed air source 150 external to the gas turbine engine 10 can also be provided. The compressed air source 150 is in fluid communication with the external source conduit 149. As shown, in a configuration of the valve 152, the compressed air source 150 is configured for guiding compressed air in sequentially in the external source conduit 149 and in the engine conduit(s) 144, through the bleed port(s) 148 and into the core gas path 38a of the gas turbine engine 10. Still referring to FIG. 2, the flow of the compressed air is depicted by dashed arrows A. By doing so, the compressed air can flow against the low and high pressure shafts 20 and 22, and the casing 32, towards an exhaust portion of the turbine section 18. By way of this flow, the low and high pressure shafts 20 and 22, and other components of the gas turbine engine 10, may be heated up or cooled down depending on whether the compressed gas delivery system 100 is operated before ignition of the gas turbine engine 10 or after the shut down of the gas turbine engine 10 has been initiated. In the latter case, the cooling down of the low and high pressure shafts 20 and 22 may reduce the risks of rotor bending. In some embodiments, the compressed air source 150 is an auxiliary power unit (APU) which is part of the aircraft but external to the gas turbine engine 10. In some other embodiments, the compressed air source 150 can be part of a ground power unit. For instance, the compressed air source 150 can be a ground-based compressed air source such as a blower motor. In these embodiments, ends of the compressed air conduit(s) 144 may be exposed thereby facilitating the connections with the ground-based compressed air source. To this end, external compressed air conduits such as external conduit 149 may be used.

In some embodiments, the flow of compressed air incoming from the compressed air source 150 may be sufficient to induce rotation of the low and/or high pressure shafts 20 and 22 up to a given rotation speed. In these embodiments, the rotation of the low and/or high pressure shafts 20 and 22 may help in dissipating heat during the pre-heating and/or cooling periods, depending on when the compressed air delivery system 100 is operated. In some embodiments, the rotation speed of the low and/or high pressure shafts 20 and 22 can be monitored over time. In these embodiments, the flow of the compressed air source 150 can be maintained and/or increased for a given period of time until the monitored rotation speed reaches a given rotation speed threshold. Either one or both of the given period of time and the given rotation speed threshold can be depending on surrounding environmental conditions. For instance, in colder weather conditions, the period of time during which compressed air is flowed radially inwardly through the bleed port(s) 148 and into the core gas path 36a may be shorter than in warmer weather conditions as the surrounding environmental conditions may contribute to the cooling of the gas turbine engine 10. The rotational speed threshold can also depend on the surrounding environmental conditions. In embodiments where cooling of the engine 10 is sought, the rotation speed threshold can be higher in colder weather conditions than in warmer weather conditions, and vice versa.

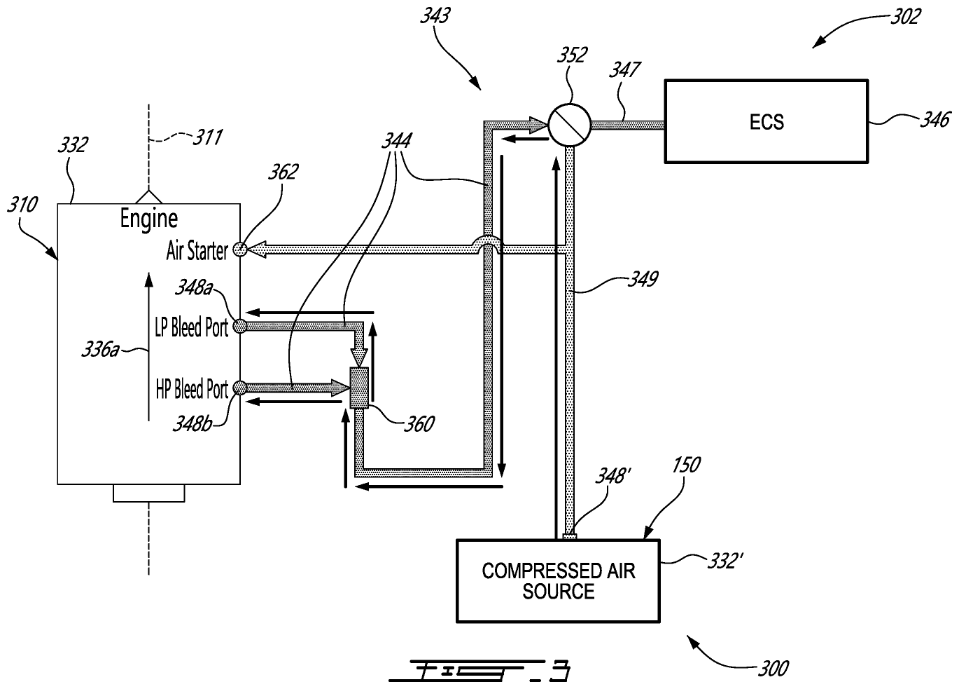

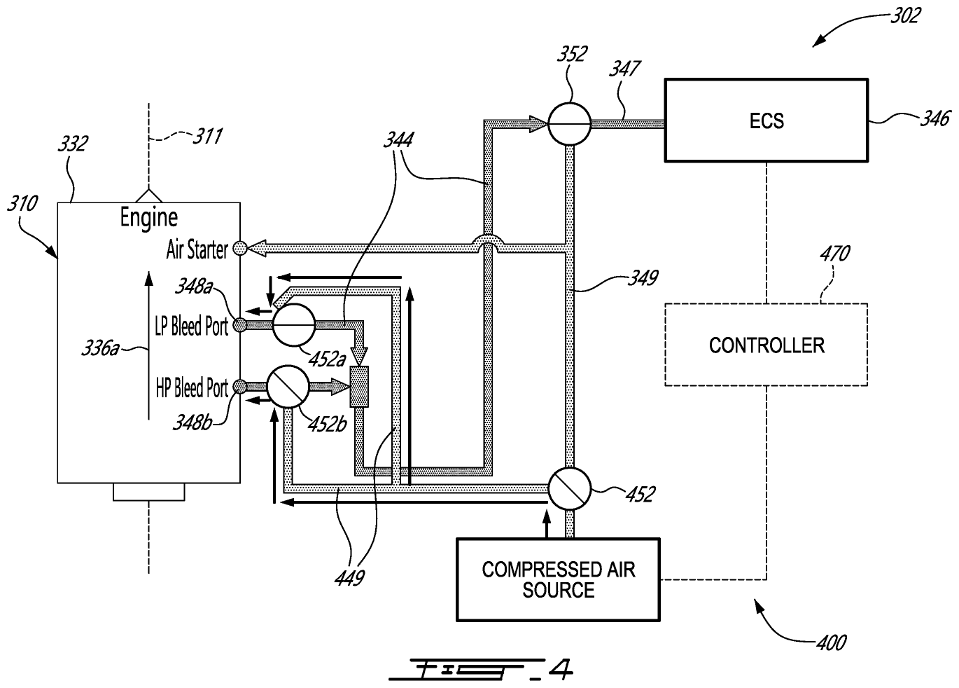

The construction of the compressed air delivery system 100 can differ from one embodiment to another. For instance, the compressed air delivery system can use existing valve and conduits of the aircraft, such as described with reference to FIG. 3, or use dedicated valve and conduits, such as described with reference to FIG. 4.

FIG. 3 shows a schematic view of an aircraft 302 having a gas turbine engine 310, an ECS 346 and an APU 350. The gas turbine engine 310 has a core gas path 336a, a casing 332 through which the core gas path 336a extends, and a rotor rotatable about a rotation axis 311 inside the casing 332. The casing 332 has a low pressure bleed port 348a located at a low pressure portion of the core gas path 36a, and a high pressure bleed port 348b located at a high pressure portion of the core gas path 336a. During normal working conditions of the gas turbine engine 310, compressed air bleeding from the low and high pressure bleed ports 348a and 348b can be mixed using a mixer 360 and then directed towards the ECS 346. Using external source conduit(s) 349, the APU 350 can convey compressed air towards an air starter 362 of the gas turbine engine 310 during the starting of the gas turbine engine 310 as well as to the ECS 346 during normal working conditions of the gas turbine engine 310. The compressed air is flowed between the APU 350, the low and high pressure bleed ports 348a and 348b and the ECS 346 using a fluid conduit network 343 incorporating a number of engine conduit(s) 344, aircraft conduit(s) 347 and external source conduit(s) 349. In some embodiments, the APU 350 supplies compressed air not only to the low pressure and high pressure bleed ports 348a and 348b but also to the air starter 362 to energize it at very low speeds. In some embodiments, the APU 350 has an auxiliary rotor casing 332′ defining an auxiliary gas path (not shown), an auxiliary bleed port 348′ open to the auxiliary gas path and in fluid communication with the valve via the external source conduit 349. As such, compressed air originating from the auxiliary bleed port 348′ of the APU 350 can be guided towards the low and high pressure bleed ports 348a and 348b of the gas turbine engine 310

In this example, a compressed air delivery system 300 is shown. As depicted, the compressed air delivery system 300 is implemented using the fluidic circuit of the aircraft 302. The compressed air delivery system 300 has the low and high pressure bleed ports 348a and 348b that are open to the core gas path 36 in the casing 332. The compressed air delivery system 300 also includes a compressed gas source external, in this case provided in the form of the aircraft-based or onboard APU 350, to the gas turbine engine 310 and in fluid communication with the low and high pressure bleed ports 348a and 348 via corresponding engine conduits 344. The fluid conduit network 343 incorporates a valve 352 in fluid communication with one or more of the engine conduit(s) 344. As shown, the valve 352 is movable from a first configuration preventing the compressed air to flow radially inwardly across the low and high pressure bleed ports 348a and 348b to a second configuration allowing the compressed air to flow radially inwardly across the low and high pressure bleed ports 348a and 348b and into the core gas path 336a. In the second configuration the valve 352 may prevent the compressed air from reaching the aircraft conduit 347. In the first position, the valve 352 can guide the compressed air drawn from the low and high pressure bleed ports 348a and 348b to the ECS 346 via a sequence of the engine conduits 344 and the aircraft conduit 347.

FIG. 4 shows the aircraft 302 equipped with another example of a compressed air delivery system 400. As shown, the compressed air delivery system 400 has dedicated external source conduits 449, i.e., separate from the compressed air conduits 344 described above, to convey compressed air from the APU 350 to the low and high pressure bleed ports bleed ports 348a and 348b. As shown, in this example, the first valve 352 is used to determine whether compressed air originates from the APU 350 or from the low and high pressure bleed ports 348a and 348b. However, the compressed air delivery system 400 has a dedicated, second valve 452 which can direct compressed air either towards the first valve 352, and ultimately the ECS 346, or towards the dedicated external source conduits 449 and associated bleed ports. As shown in this example, the low and high pressure bleed ports 348a and 348b have corresponding low pressure and high pressure valves 452a and 452b that are controllable to allow or restrict compressed air flow. Each of the valves 352, 452, 452a and 452b are controllable independently from one another, depending on the embodiment. The low pressure and high pressure valves 452a and 452b typically regulate the flow of compressed air supplied to the ECS 346 during normal working conditions of the gas turbine engine 310. In view of the above, the low pressure and high pressure valves 452a and 452b can also regulate the flow of compressed air to the core gas path 338 during shutdown of the gas turbine engine 310. The compressed air guided through the low pressure bleed port 348a can provide a pressure resistance (back-pressure) to the compressed air guided through the high pressure bleed port 348b such that its diffusion towards the forward, cold-end of the gas turbine engine is restricted. In some embodiments, the external source conduit 449 in fluid communication with the low pressure bleed port can be omitted.

As shown in this embodiment, there is provided a controller 470 communicatively coupled to the ECS 346, the APU 350, the valves 352, 452, 452a and 452b, and/or other aircraft or engine sensor(s). In this embodiment, the controller 470 has a processor and a computer-readably memory having stored thereon instructions that when executed by the processor can control the operation of the compressed air delivery system 400. For instance, upon receiving a command to pre-heat the gas turbine engine 310, the controller 470 may move the second valve 452 into a configuration guiding compressed air from the APU 350 in the dedicated external source conduits 449 and radially inwardly across the low and high pressure ports 348a and 348b. Once it has been determined that the gas turbine engine 310 has been satisfactorily pre-heated, the controller 470 may move the valve 452 into another configuration favoring compressed air to be bled out of the casing 332. In some other embodiments, the controller 470 may detect that a shutdown sequence of the gas turbine engine 310 has been initiated, for instance by detecting that the engine rotors rotate at a rotation speed below corresponding idle rotation speeds and/or by detecting that fuel supply has been stopped. In these embodiments, the controller 470 may the initiate a shutdown of the gas turbine engine 310, the controller 470 may move the second valve 452 into a configuration guiding compressed air from the APU 350 in the dedicated external source conduits 449 and radially inwardly across the low and high pressure ports 348a and 348b and into the core gas path 336a.

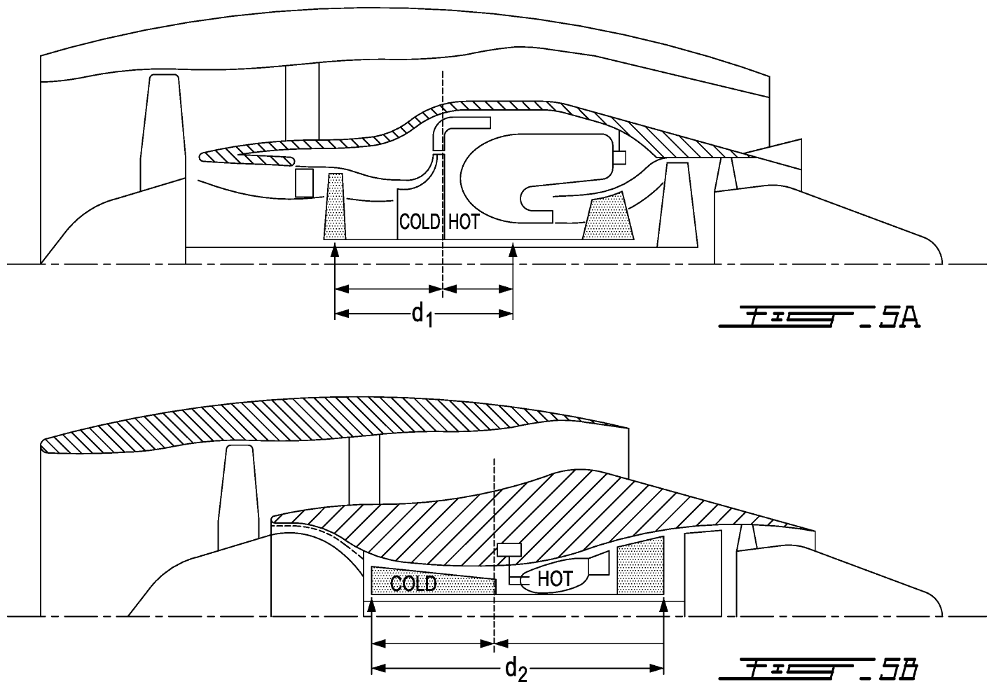

The compressed air delivery systems described above may be implemented in any type of gas turbine engine. However, it was found useful to implement such systems in gas turbine engines which are more prone to rotor bow. FIGS. 5A and 5B show exemplary gas turbine engines having their rotors supported by bearings which are spaced-apart by first and second axial distances d1 and d2, respectively. As can be appreciated, the gas turbine engine of FIG. 5B may be more prone to rotor bow than the gas turbine engine of FIG. 5A as the length of unsupported rotor is greater, i.e. d2>d1. Accordingly, the benefits of implementing a compressed air delivery system such as the one described herein may be more apparent for the gas turbine engine of FIG. 5A than for that of FIG. 5B, although there are also benefits in implementing the compressed air delivery system to the gas turbine engine of FIG. 5A in some circumstances. One aspect of importance in the rotor bow prevention is the spacing of the high pressure shaft bearings and the portion of unsupported shaft that lies within a “hot” zone as depicted by the dashed line in FIGS. 5A and 5B. As typical engines have a “hot bearing,” i.e., a bearing usually underneath the combustion chamber, this shortens the amount of unsupported shaft in the hot zone. Typical engines also use an impeller, versus an all axial high pressure compressor. This shortens the overall length of the high pressure shaft; hence, shortens the unsupported section in the hot zone, and the overall impact of rotor bow. As some gas turbine engines have <40 or 30% of their unsupported length in the hot zone, some other gas turbine engines may have >50% of their unsupported length in the hot zone. Using a compressed air delivery system such as the ones described herein may have significant benefits when used with the latter engines.

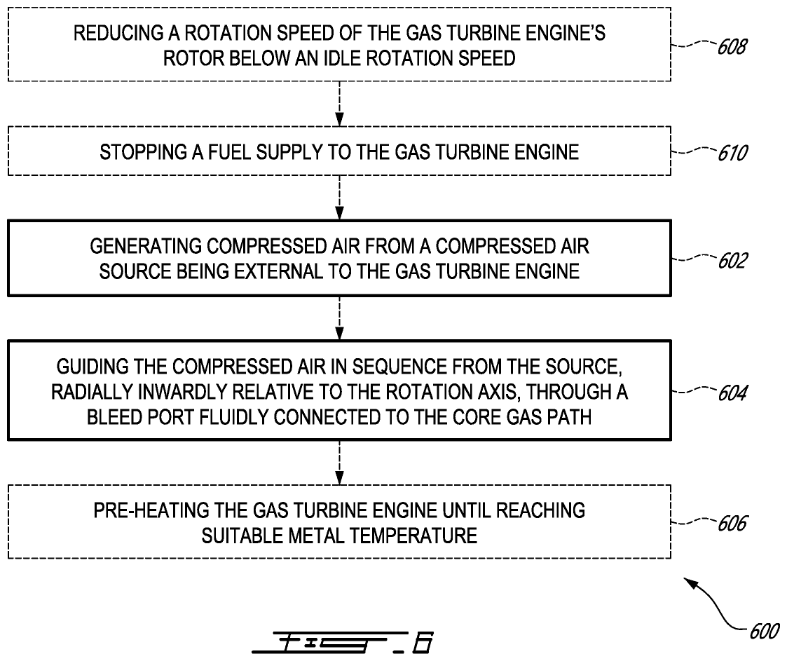

FIG. 6 shows a flow chart of a method 600 of operating a gas turbine engine. As discussed, the gas turbine engine has a rotor rotatable about a rotation axis, a core gas path defined annularly around the rotation axis, and a casing defining a radially outer wall to the core gas path.

The method has a step 602 of generating compressed air from a compressed air source, the compressed air source being external relative the gas turbine engine, and a step 604 of guiding the compressed air in sequence from the source, radially inwardly relative the rotation axis, through a bleed port fluidly connected to the core gas path.

In some embodiments, the compressed air source is an aircraft-based APU. In these embodiments, the step 604 of guiding the compressed air can include a step of moving a valve from a first configuration preventing the compressed air to flow through the bleed port to a second configuration allowing the compressed air to flow radially inwardly through the bleed port. In some embodiments, the compressed air source is a ground-based compressed air source. In these embodiments, a step of moving a valve from the first configuration to the second configuration may be performed as well. Additionally, in these embodiments, the step 604 of guiding the compressed air includes a step of bringing an external compressed air conduit in fluid communication between the compressed air source and the bleed port. In this case, the compressed air conduit may be an external compressed air conduit having end connectors connectable to corresponding connectors of the aircraft and/or gas turbine engine. Using both the aircraft-based APU and the ground-based compressed air source may be envisaged in some embodiments. In some embodiments, the aircraft-based APU can be substituted by an auxiliary air-pump that is powered by alternate means.

In embodiments where the gas turbine is already hot, the step 602 of guiding the compressed air includes a step of cooling the core gas path, the rotor, the radially outer wall of the casing, and other engine components. In embodiments where the gas turbine is cold, the step 602 of guiding the compressed air includes a step of warming the core gas path, the rotor, the radially outer wall of the casing, and other engine components. In either case, the compressed air guided through the bleed port can be used for forced-convective cooling and/or warming of the gas turbine engine using the compressed air from a non-engine related compressed air source such as the APU or a stand-alone blower motor.

In some embodiments, the step 604 of guiding the compressed air induces rotation of the rotor up to a given rotation speed. In these embodiments, the rotation of the rotor may not be induced by rotation of the air starter but rather by compressed air acting on blades (e.g., aerofoils) of the rotor. The rotation speed is generally kept well below an idle rotation speed of the corresponding rotor. For example, the idle rotation speed for a high pressure rotor can be 17,000 RPM whereas the idle rotation speed for a low pressure rotor can be 1,500 RPM. As such, the compressed air guided through the bleed port can cause the high pressure rotor to rotate at a speed of about 300-400 RPM or even lower in some embodiments. The compressed air can be used to rotate the low pressure and/or high pressure rotors at 2% of the corresponding idle rotation speed, and preferably 10% of the corresponding idle rotation speed of the rotation speed. The flow of compressed air radially inwardly through the bleed port(s) may be maintained and/or increased for a given period of time up until the rotation speed of the rotor reaches a given rotation speed threshold. In these embodiments, either one or both of the given period of time and the given rotation speed threshold can be dependent upon surrounding environmental conditions.

When the gas turbine engine has been left inoperative for several hours in cold climate, it can be difficult to start. In such conditions, it may be desirable to pre-heat the engine, and more specifically the components surrounding the combustor including the combustor itself, prior to ignition. In such embodiments, the method 600, and more specifically the step 604, can be performed until the core gas path and/or the rotor(s) have reached a given temperature. When it is determined that the gas turbine engine has been satisfactorily pre-heated, a step 606 of pre-heating the gas turbine engine until reaching suitable metal temperature. Then, in some embodiments, the method can include a step of igniting the gas turbine engine. In some embodiments, the flow of compressed air radially inwardly through the bleed port(s) and into the core gas path is maintained throughout pre-heating and ignition and perhaps until a given period of time has elapsed. In some other embodiments, the flow of compressed air radially inwardly through the bleed port(s) and into the core gas path is stopped immediately prior to the step 606 of pre-heating the gas turbine engine.

In some embodiments, especially those in which the gas turbine engine has been running for a while and in which shutting down of the gas turbine engine is sought, the step 604 can be performed in order to cool the core gas path to prevent rotor bow such as introduced above. In these embodiments, the step 604 may be performed only when some conditions indicating of the shutting down of the gas turbine engine have been met. For instance, the method 600 has a step 608 of reducing a rotation speed of the engine's rotor is below idle rotation speed. For example, the idle rotation speed for a high pressure rotor can be 17,000 RPM whereas the idle rotation speed for a low pressure rotor can be 1,500 RPM. When that such speed reduction occurs, step 604 may be performed. In some embodiments, the method 600 has a step 610 of stopping fuel supply to the gas turbine engine. In these embodiments, when the fuel supply is stopped, step 604 is performed thereafter. In some embodiments, step 604 may be performed only upon determining that both the steps 608 and 610 have been performed.

In some embodiments, the method 600 can pre-heat the gas turbine engine prior to ignition in order to assist in cold-starts. When using a ground-based compressed air source, the fuel consumption may also be reduced at the aircraft level. The method 600 can allow the gas turbine engine to be completely shut-down sooner after landing thanks to the cooling thereby reducing noise pollution. Moreover, using the APU for engine cooling can help reduce the wait times from arrival at the gate until the deplaning.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, the valve between the external compressed air source and the bleed port(s) can be omitted. External to the gas turbine engine can refer to external to the casing, or external to the nacelle, for instance. It is intended that the method described herein can be used to assist in cold-starts by pre-heating the engine hardware to avoid frame-quenching. In some embodiments, compressed air may be flowed radially inwardly across bleed port(s) open in the bypass gas path to pre-heat and/or cool the core engine casing and/or the nacelle, in some embodiments. Yet further modifications could be implemented by a person of ordinary skill in the art in view of the present disclosure, which modifications would be within the scope of the present technology.

1. A method of operating a gas turbine engine, the gas turbine engine having a rotor rotatable about a rotation axis, a core gas path defined annularly around the rotation axis, and a casing defining a wall to the core gas path, the method comprising:
generating compressed air from a compressed air source, the compressed air source being external relative the gas turbine engine; and
guiding the compressed air in sequence from the compressed air source, radially inwardly relative the rotation axis, through a bleed port and into the core gas path.

2. The method of claim 1 wherein the compressed air source is an aircraft-based auxiliary power unit, said guiding including redirecting compressed air destined to an aircraft system towards the bleed port.

3. The method of claim 1 wherein the compressed air source is a ground-based power unit, said guiding the compressed air includes bringing an external compressed air conduit in fluid communication between the compressed air source and the bleed port.

4. The method of claim 1 wherein the guiding the compressed air includes cooling at least the core gas path, the rotor and the radially outer wall of the casing.

5. The method of claim 1 wherein the guiding the compressed air includes warming at least the core gas path, the rotor and the radially outer wall of the casing.

6. The method of claim 1 further comprising, prior to the guiding the compressed air, reducing a rotation speed of the rotor below a idle rotational speed of the gas turbine engine.

7. The method of claim 1 further comprising, prior to the guiding the compressed air, stopping a fuel supply to the gas turbine engine.

8. The method of claim 1 wherein said guiding includes pre-heating the gas turbine engine until reaching suitable metal temperature.

9. The method of claim 1 further comprising a valve in fluid communication between the compressed air source and the bleed port, said guiding including moving the valve from a first configuration guiding the compressed air between the bleed port and an aircraft system to a second configuration allowing the compressed air to flow radially inwardly through the bleed port.

10. The method of claim 1 wherein said guiding inducing rotation of the rotor up to a given rotation speed, said given rotation speed being below an idle rotation speed.

11. The method of claim 10 wherein the given rotation speed is up to 10% of the idle rotation speed.

12. The method of claim 1 wherein said guiding is performed for a given period of time depending upon surrounding environmental conditions.

13. A compressed air delivery system for an aircraft having a gas turbine engine, an aircraft system, and a fluid conduit network, the gas turbine engine having a rotor rotatable about a rotation axis, a core gas path defined annularly around the rotation axis, a casing defining a wall to the core gas path, a bleed port in the wall, open to the core gas path, the fluid conduit network configured for fluidly connecting the bleed port to the aircraft system sequentially via an engine conduit extending radially outwardly relative the rotation axis and an aircraft conduit extending externally relative the gas turbine engine, the compressed air delivery system comprising:
at least one valve and an external source conduit fluidly integrated to the fluid conduit network, the at least one valve selectively operable to
a first configuration fluidly connecting the engine conduit to the aircraft conduit and partitioning the external source conduit, and
a second configuration fluidly connecting the engine conduit to the external source conduit and partitioning the aircraft conduit.

14. The compressed air delivery system of claim 13 wherein the compressed air source is an aircraft-based auxiliary power unit having an auxiliary rotor casing defining an auxiliary gas path, and an auxiliary bleed port open to the auxiliary gas path in fluid communication with the external source conduit.

15. The compressed air delivery system of claim 13 wherein the bleed port has a low pressure bleed port located at a low pressure portion of the core gas path and a high pressure bleed port located a high pressure portion of the core gas path.

16. The compressed air delivery system of claim 15 wherein the engine conduit has a first engine conduit in fluid communication with the low pressure bleed port a second engine conduit in fluid communication with the high pressure bleed port, the first and second engine conduits being fluidly integrated to the fluid conduit network.

17. The compressed air delivery system of claim 16 wherein the fluid conduit network has a low pressure valve in fluid communication with the first engine conduit and a high pressure valve in fluid communication with the second engine conduit.

18. The compressed air delivery system of claim 17 wherein the low pressure valve and the high pressure valve being selectively operable to control flows of compressed gas guided through respective ones of the low pressure bleed port and the high pressure bleed port.

19. An aircraft comprising:
an aircraft system;
a gas turbine engine having a rotor rotatable about a rotation axis, a core gas path defined annularly around the rotation axis, a casing defining a wall to the core gas path, a bleed port in the casing open to the core gas path;
a fluid conduit network configured for fluidly connecting the bleed port to the aircraft system sequentially via an engine conduit extending radially outwardly relative the rotation axis and an aircraft conduit extending externally relative the gas turbine engine, the fluid conduit network having a valve and an external source conduit fluidly integrated thereto; and
a compressed air source configured for generating compressed air and guiding the compressed air into the external source conduit;
the valve being selectively operable to a first configuration fluidly connecting the engine conduit to the aircraft conduit, and to a second configuration fluidly connecting the engine conduit to the external source conduit and partitioning the aircraft conduit.

20. The aircraft of claim 19 wherein the compressed air source is an auxiliary power unit of the aircraft having an auxiliary rotor casing defining an auxiliary gas path, an auxiliary bleed port open to the auxiliary gas path and in fluid communication with the valve via the fluid conduit network.
